(19) United States
(12) Patent Application Publication
(10) Pub. No.: US 2007/0057018 A1
(43) Pub. Date: Mar. 15, 2007

(54) SOLDERING APPARATUS

(75) Inventor: Seiji KAWAGUCHI, Tokyo (JP)

Correspondence Address: PATENTTM.US, P. O. BOX 82788, PORTLAND, OR, 97282-0788, US

(73) Assignee: APOLLO SEIKO LTD., Tokyo (JP)

(21) Appl. No.: 11/422,039

(22) Filed: Jun. 2, 2006

(30) Foreign Application Priority Data
Sep. 14, 2005 (JP) 2005-266982

(51) Int. Cl. A47J 36/02

(52) U.S. Cl. 228/101

(57) ABSTRACT

There is provided a soldering apparatus that can supply nitrogen gas to each soldering iron, is low in cost, and can increase the workability. A soldering apparatus 100 includes a soldering iron unit 300 having an iron tip heated by a heater unit and a blowout nozzle for blowing out nitrogen gas from near the iron tip; and a control unit 200 connected to the soldering iron unit 300. The control unit 200 incorporates a nitrogen gas supply mechanism for separating nitrogen gas from compressed air by using a hollow yarn bundle serving as a semipermeable membrane for separating nitrogen, which is formed by bundling a plurality of hollow yarns.

### BACKGROUND OF THE INVENTION

1. Field of the Invention

The present invention relates to a soldering apparatus for performing soldering while nitrogen gas etc. are sprayed from the tip of a soldering iron.

2. Description of the Related Art

As one of recent environmental issues, the use of a leadless solder in soldering electrical parts is about to be made compulsory. In manual soldering operation using a thread solder, in the case where soldering is performed using a leadless solder, the melting temperature of solder is high and the flow of solder to the target point of soldering deteriorates, so that the defective ratio of soldering increases under the present conditions. To solve this problem, a configuration has been proposed in which a nitrogen gas blowout nozzle is provided around the tip of a soldering iron (for example, refer to Japanese Patent Laid-Open No. 2004-351420), a nitrogen gas generator is provided on the outside (for example, refer to Japanese Patent Laid-Open No. 10-87305), and the generated nitrogen gas is introduced to the blowout nozzle. By performing soldering operation while nitrogen gas is sprayed on an area near the point to be soldered by using this configuration, the oxidation of molten solder can be restrained, and the deterioration in solder flow can be improved.

For the soldering iron disclosed in Japanese Patent Laid-Open No. 2004-351420, an inert gas supplying tube member and an electric wiring cable are connected separately to a handle base integrated with a holding handle, so that at the time of soldering operation, the tube member and the cable are dragged about at the same time, and therefore a problem of poor workability arises. Also, a gas lead-out tube is provided around a heater cartridge in a state in which a gap is secured between the gas lead-out tube and the periphery of the tip portion of heater cartridge, so that the outside diameter of the tip portion of soldering iron increases, which decreases the workability.

The nitrogen gas generator disclosed in Japanese Patent Laid-Open No. 10-87305 is provided as an individual device independent of the soldering iron, a power supply unit connected to the soldering iron via the electric wiring cable, and the like, and moreover the whole of the apparatus is large in size. Therefore, considering economical efficiency, it is thought that nitrogen gas is supplied from one nitrogen gas generator for a plurality of soldering irons. In this case, however, control such as flow control must be carried out each time the number of soldering irons to which nitrogen gas is supplied changes, which causes great inconvenience. To overcome such a disadvantage, there has been demanded a low-cost configuration capable of supplying nitrogen gas individually to each soldering iron.

Furthermore, the temperature of the tip portion of the heater cartridge of the soldering iron (iron tip) for a leadless solder must be 30 to 50° C. higher than the temperature thereof in the case of a lead-containing solder. Therefore, the solder wetted surface of iron tip oxidizes rapidly, so that cleaning must be performed frequently. Generally, the cleaning is performed by using a heat-resistant sponge moistened with water and by rubbing the iron tip against the sponge. For this purpose, the sponge must always be kept in a moistened state, and moreover rubbed-out solder residues must be cleaned. Therefore, there arises a problem in that the maintenance during work requires much labor and time, which results in poor workability.

### SUMMARY OF THE INVENTION

The present invention has been made in view of the above-described circumstances, and accordingly an object thereof is to provide a soldering apparatus that can supply nitrogen gas to each soldering iron, is low in cost, and can increase the workability.

To solve the above-described problems, a soldering apparatus in accordance with the present invention includes a soldering iron unit having an iron tip heated by a heater unit and a blowout nozzle for blowing out nitrogen gas from near the iron tip; and a control unit connected to the soldering iron unit, and the control unit incorporates a nitrogen gas supply mechanism for separating nitrogen gas from compressed air by using a hollow yarn bundle serving as a semipermeable membrane for separating nitrogen, which is formed by bundling a plurality of hollow yarns. By incorporating the nitrogen gas supply mechanism in the control unit of the soldering apparatus, nitrogen gas can be supplied to each soldering iron unit, so that flow control etc. can be carried out for each soldering iron unit. Therefore, the operability and workability can be increased.

The above-described hollow yarn bundle is preferably stored in a turned state in a storage chamber provided in the control unit. By using the turned hollow yarn bundle, the hollow yarn bundle can be stored in the control unit, so that the size and cost of the soldering apparatus including the control unit can be reduced.

It is preferable that the above-described hollow yarn bundle can be freely attached to and detached from a joint provided on the control unit. Thereby, the hollow yarn bundle is easily replaced at regular time intervals, so that the workability can be increased.

It is preferable that the above-described storage chamber can be freely attached to and detached from the control unit in a state in which the hollow yarn bundle is stored. Thereby, a cassette that stores the hollow yarn bundle has only to be replaced. Therefore, the replacement work is further easy, and damage etc. occurring at the work time can be prevented as compared with the case where only the hollow yarn bundle is replaced in an exposed state.

It is preferable that the above-described soldering iron unit and control unit be connected to each other via a tubular member having flexibility and being capable of maintaining gastightness of the internal space thereof, and a heater cable for supplying a current to the heater unit be contained in the tubular member in a state in which some internal space of the tubular member is left, thereby using the internal space as a nitrogen gas supply path. Thereby, the soldering iron unit and the control unit can be connected to each other via one tubular member, so that the tubular member can easily be dragged about as compared with the case where an electrical wiring and a nitrogen gas supply tube are provided separately, which further increases the workability.

It is also preferable that above-described iron tip have an outer peripheral surface that is in close contact with the inner peripheral surface of the blowout nozzle, and have a blowout groove for blowing out nitrogen gas in a part of the outer peripheral surface. Thereby, the diameter of the blowout nozzle surrounding the iron tip can be decreased, by which the workability can be increased.

Also, it is preferable that the above-described control unit further include a rotating sponge element and a turning pin which supplies water in a water tank to the sponge element while rotating and removes solder residues adhering to the face of the sponge element. Thereby, the sponge element serving as an iron tip cleaner can always be kept in a state of being moistened with water. Moreover, since solder residues adhering to the sponge element can be removed automatically, the labor and time for maintenance requiring the interruption of soldering work can be reduced significantly.

### BRIEF DESCRIPTION OF THE DRAWINGS

FIG. 1 is a perspective view showing the whole of a soldering apparatus in accordance with one embodiment;

FIG. 2 is a front view of a control unit;

FIG. 3 is a side view of a control unit;

FIG. 4 is a partially sectional view of a control unit, showing the details of the rotation mechanism of a sponge cleaner and a turning pin;

FIG. 5 is a view showing the detailed cross section of a soldering iron unit;

FIG. 6 is a view showing the detailed cross section of a soldering iron unit;

FIG. 7 is an enlarged sectional view of a blowout nozzle;

FIG. 8 is a view showing the general construction of a nitrogen gas supply mechanism;

FIG. 9 is a side view of a hollow yarn bundle contained in a nitrogen gas supply mechanism;

FIG. 10 is a view showing a state in which a hollow yarn bundle is extended into a straight line shape;

FIG. 11 is an enlarged side view showing an end portion of the hollow yarn bundle shown in FIG. 10;

FIG. 12 is a sectional view of a hollow yarn bundle cassette;

FIG. 13 is a side view of a hollow yarn bundle cassette; and

FIG. 14 is a top view of a hollow yarn bundle cassette.

### DETAILED DESCRIPTION OF THE PREFERRED EMBODIMENTS

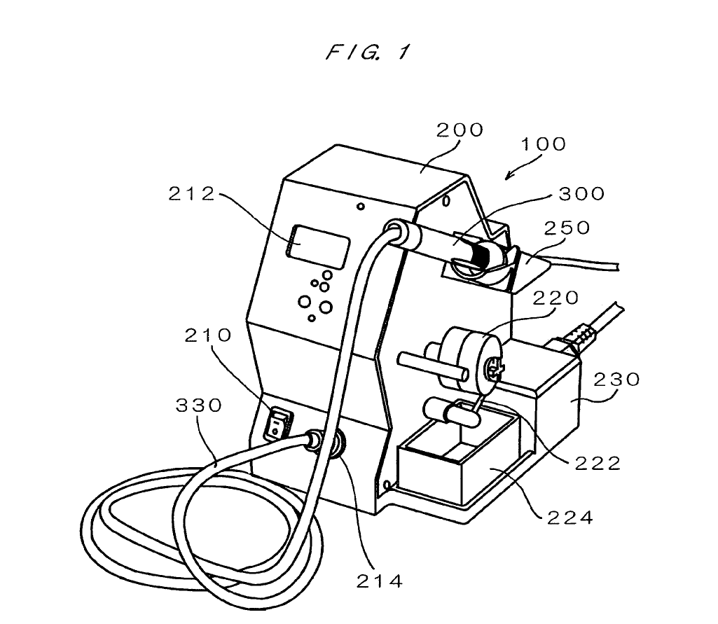

One embodiment of a soldering apparatus to which the present invention is applied will now be described in detail with reference to the accompanying drawings. FIG. 1 is a perspective view showing the whole of a soldering apparatus in accordance with one embodiment. As shown in FIG. 1, a soldering apparatus 100 of this embodiment includes a control unit 200 and a soldering iron unit 300.

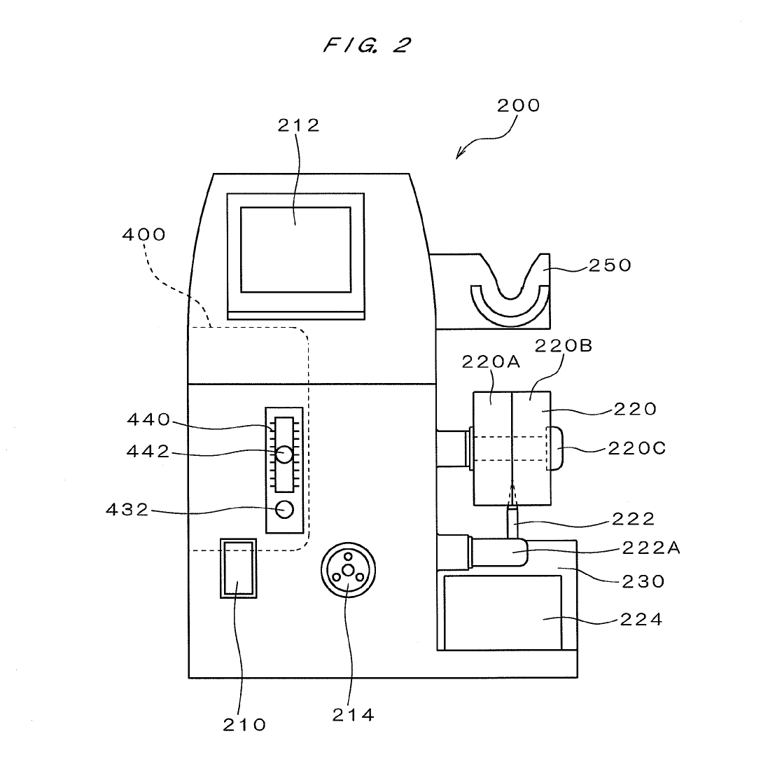

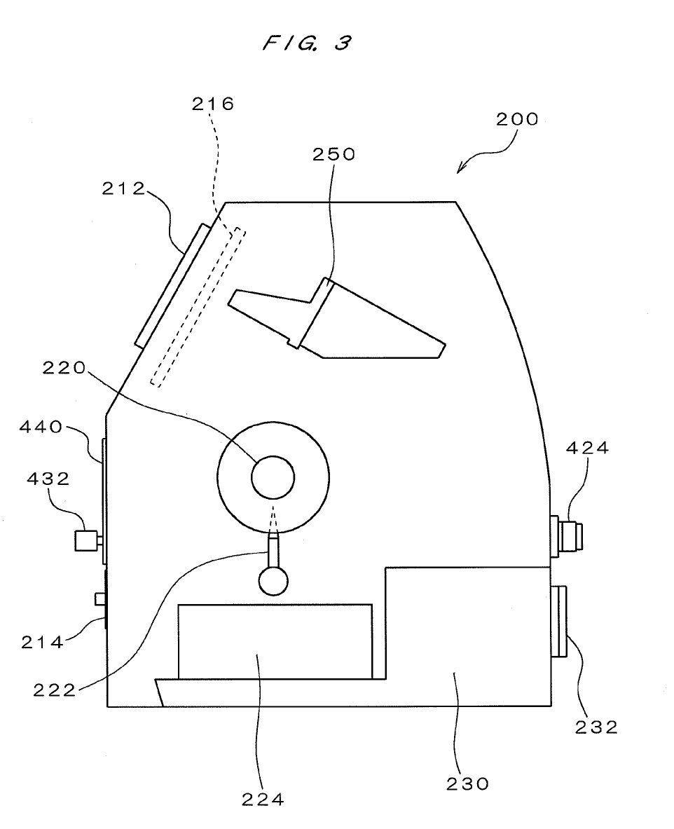

FIG. 2 is a front view of the control unit 200, and FIG. 3 is a side view of the control unit 200. As shown in FIGS. 2 and 3, on the front surface of the control unit 200, a power switch 210, a temperature display panel 212, and an iron connector 214 are arranged. Also, at the right-hand side thereof, a sponge cleaner 220, a turning pin 222, a water tank 224, a power unit 230, and an iron stand 250 are arranged.

The power switch 210 gives directions to start or finish the operation of the soldering apparatus 100 of this embodiment. When the power switch 210 is turned on, heating operation, temperature control operation, and nitrogen gas supplying operation for the soldering iron unit 300 is started, and when the power switch 210 is turned off, these operations are stopped. The temperature display panel 212, which displays the iron tip temperature of the soldering iron unit 300, is formed of an LCD (Liquid Crystal Display), an LED (Light Emitting Diode), or the like. For example, in a case where the temperature exceeds the normal range or where a trouble occurs in the current path, the temperature display panel 212 displays an alarm according to the content of abnormality. The control of the whole of the soldering apparatus 100 is carried out by an electronic circuit provided on a control substrate 216 in the control unit 200. Also, the power unit 230 is connected to an AC power source via a power cord (not shown) connected to an AC power receptacle 232.

The iron connector 214 is a connector for connecting one end of a cable-containing tube 330, the other end of which is connected to the soldering iron unit 300, to the control unit 200. Through this iron connector 214, heating power and nitrogen gas are supplied from the control unit 200 to the soldering iron unit 300. The iron stand 250 is used to put the soldering iron unit 300 thereon when the worker discontinues soldering work or when the soldering apparatus 100 is out of operation.

The sponge cleaner 220 is used by combining two disc-shaped sponge elements 220A and 220B, each of which is formed of a heat-resistant material. These two sponge elements 220A and 220B are installed in a state of being superimposed on each other through a sponge roller shaft 220C so that the two sponge elements 220A and 220B are rotated in one direction by the rotation of the sponge roller shaft 220C.

The turning pin 222 is radially attached to a part of a pin shaft 222A so that the turning pin 222 is rotated in one direction by the rotation of the pin shaft 222A. Also, the turning pin 222 is configured so that at the time of rotation, the tip portion thereof passes through between the surfaces of the sponge elements 220A and 220B facing each other at a predetermined rotation position, and the tip portion thereof passes through in water filled in the water tank 224 at another rotation position. When the tip portion of the turning pin 222, which passes through in water in the water tank 224 and is moistened, passes through between the two sponge elements 220A and 220B, water adhering to the tip portion can be supplied to the sponge elements 220A and 220B. Therefore, the surfaces of the two sponge elements 220A and 220B facing each other are always kept in a wet state. By wiping the iron tip of the soldering iron unit 300 with the wet surfaces of the two sponge elements 220A and 220B facing each other, solder residues having oxidized at the iron tip adhere to the surfaces facing each other. The turning pin 222 performs work for scraping off the adhering solder residues at the same time.

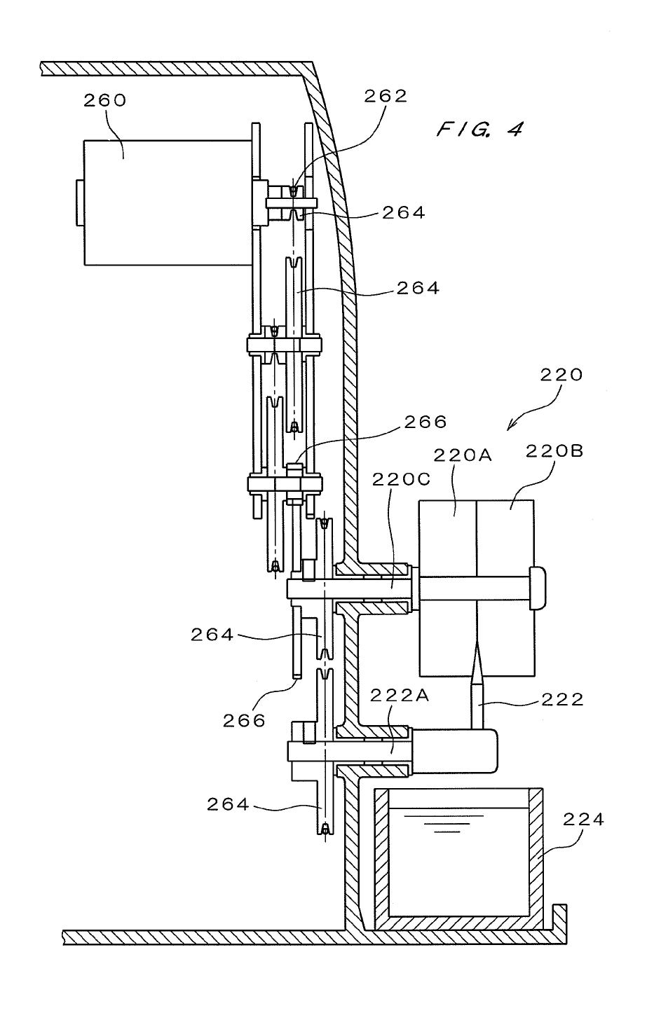

FIG. 4 is a partially sectional view of the control unit 200, showing the details of the rotation mechanism of the sponge cleaner 220 and the turning pin 222. As shown in FIG. 4, the turning force of a motor 260 is transmitted to the sponge roller shaft 220C and the pin shaft 222A via a speed reducing mechanism formed by a combination of a plurality of pulleys 264 connected by belts 262 and gears 266, so that the sponge cleaner 220 and the turning pin 222 are rotated at the same time by the rotation of the motor 260. The pulley ratio between the pulley 264 fitted on the sponge roller shaft 220C and the pulley 264 fitted on the pin shaft 222A is set so as to be other than 1 (or an integer of 2 or more) so that the turning pin 222 passes through different positions of the sponge elements 220A and 220B for each rotation.

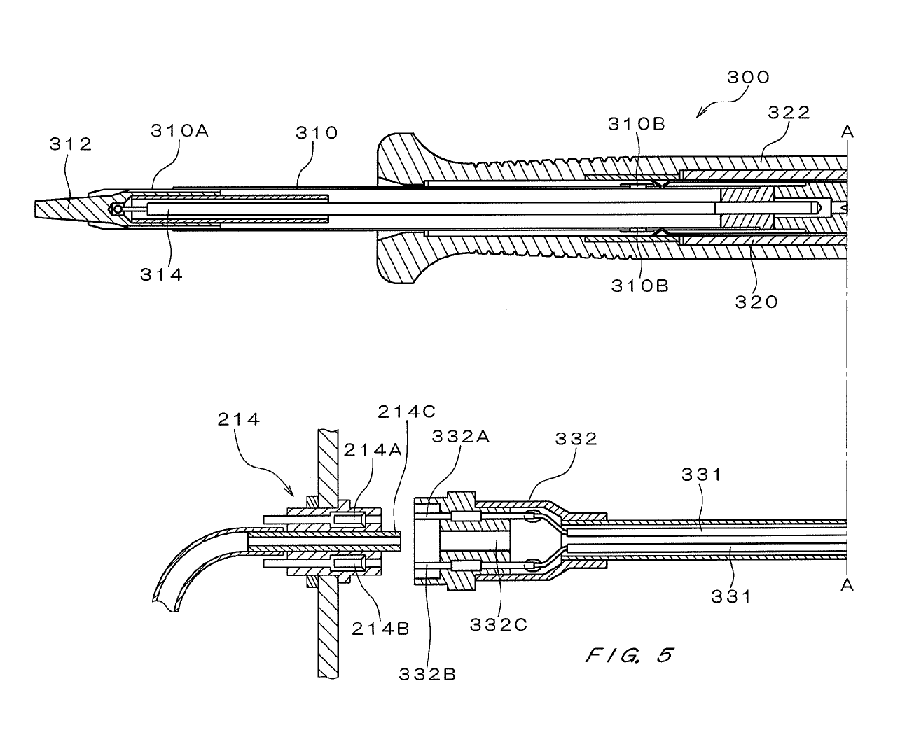

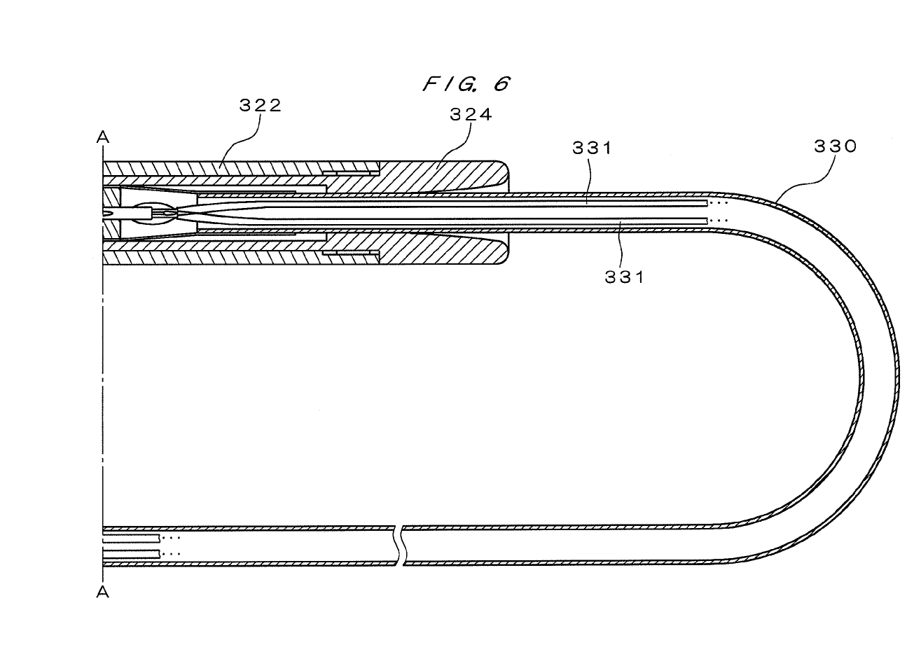

FIGS. 5 and 6 are views showing the detailed cross section of the soldering iron unit 300. FIG. 5 shows a part of the soldering iron unit 300, and FIG. 6 shows the remaining part of the soldering iron unit 300. The whole of the soldering iron unit 300 is shown by FIGS. 5 and 6. As shown in these figures, the soldering iron unit 300 includes an iron tip cartridge 310, an iron tip 312, a heater element 314, a cartridge holder pipe 320, an iron grip 322, an iron cap 324, the cable-containing tube 330, and a male connector 332.

The iron tip cartridge 310 is a tubular member. One end of the iron tip cartridge 310 forms a blowout nozzle 310A for blowing out nitrogen gas, and the other end thereof is accommodated in the cartridge holder pipe 320. On the inner periphery side of the blowout nozzle 310A, the iron tip 312 is disposed.

FIG. 7 is an enlarged sectional view of the blowout nozzle 310A. As shown in FIG. 7, the iron tip 312 is surrounded by the blowout nozzle 310A of the iron tip cartridge 310. The tip end portion of the iron tip 312 exposed from the blowout nozzle 310A has a tapered shape. Also, the iron tip 312 has blowout grooves 312A and 312B for blowing out nitrogen gas, the blowout grooves 312A and 312B being provided at two places at an interval of 180° in an outer peripheral portion contacting with the blowout nozzle 310A. In this embodiment, since the two blowout grooves 312A and 312B are formed as described above, there is no need for forming a gap between the iron tip 312 and the blowout nozzle 310A throughout the whole circumference, so that the size in the radial direction can be decreased accordingly. The number of blowout grooves is not limited to two.

The iron grip 322 and the iron cap 324 are provided with the cartridge holder pipe 320 mounted with the iron tip cartridge 310 at one end of the cartridge holder pipe 320 in a detachable state. On one end side of the cartridge holder pipe 320, the heater element 314 is mounted so as to project to one end side, and to the other end side thereof, the cable-containing tube 330 is connected electrically in a state in which the gastightness is maintained along with the internal space of the cartridge holder pipe 320. The iron tip cartridge 310 has a plurality of gas inlet holes 310B at positions where the iron tip cartridge 310 overlaps with the cartridge holder pipe 320 when the cartridge holder pipe 320 is installed. In a state in which the iron tip cartridge 310 is installed to the cartridge holder pipe 320 contained in the iron grip 322, the internal space of the cable-containing tube 330 and the internal space of the cartridge holder pipe 320 communicate with each other, and further the internal space of the cartridge holder pipe 320 and the internal space of the iron tip cartridge 310 communicate with each other via the gas inlet holes 310B. Therefore, when nitrogen gas is supplied through the cable-containing tube 330, the nitrogen gas passes in the cartridge holder pipe 320 and is guided to the internal space of the iron tip cartridge 310, and then is blown out from the blowout grooves 312A and 312B formed between the iron tip 312 mounted at the tip of the iron tip cartridge 310 and the blowout nozzle 310A.

The cable-containing tube 330, which is a tubular member having flexibility and being capable of maintaining the gastightness of internal space, contains heater cables 331. The inside diameter of the cable-containing tube 330 is set so as to be sufficiently large as compared with the diameters of the heater cables 331, so that a space formed therebetween is used as a supply path for nitrogen gas.

The male connector 332 terminates one end (opposite side to the iron tip 312) of the cable-containing tube 330, and is installed to the iron connector 214 serving as a female connector provided on the control unit 200. The male connector 332 has connection terminals 332A and 332B that terminate the heater cables 331 and a nitrogen gas introduction hole 332C. When the male connector 332 is installed to the iron connector 214, the connection terminals 332A and 332B are connected electrically to connection terminals 214A and 214B of the iron connector 214. Also, the nitrogen gas introduction hole 332C is fitted onto a nitrogen gas supply tube 214C of the iron connector 214. Thereby, current supply and nitrogen gas supply can be accomplished at the same time via a set of the male connector 332 and the iron connector 214.

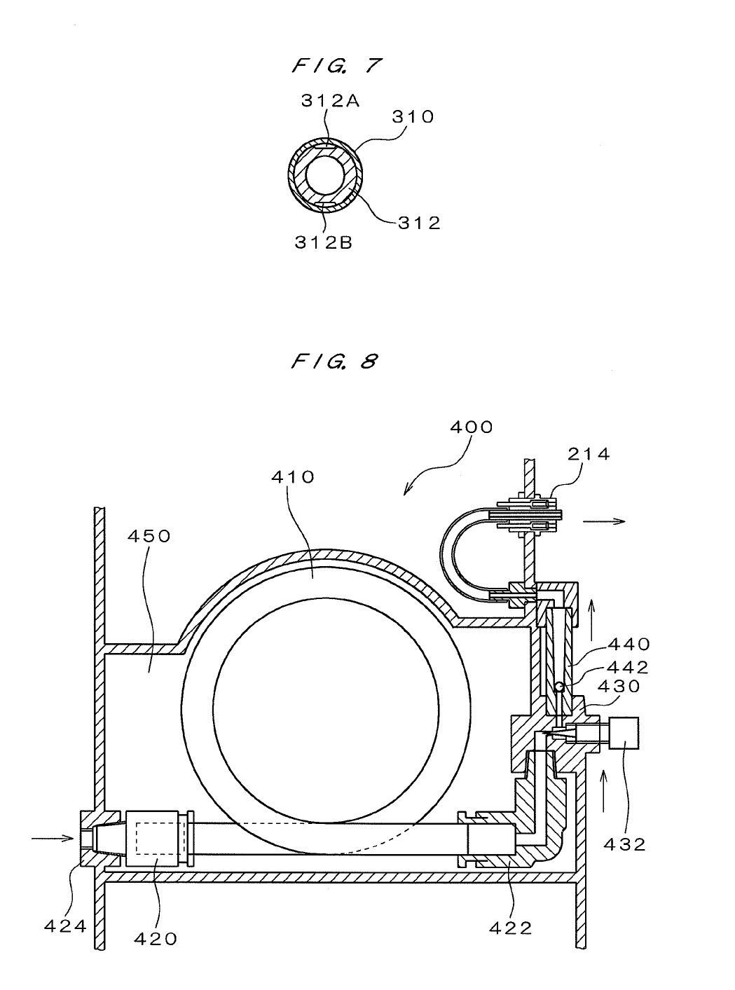

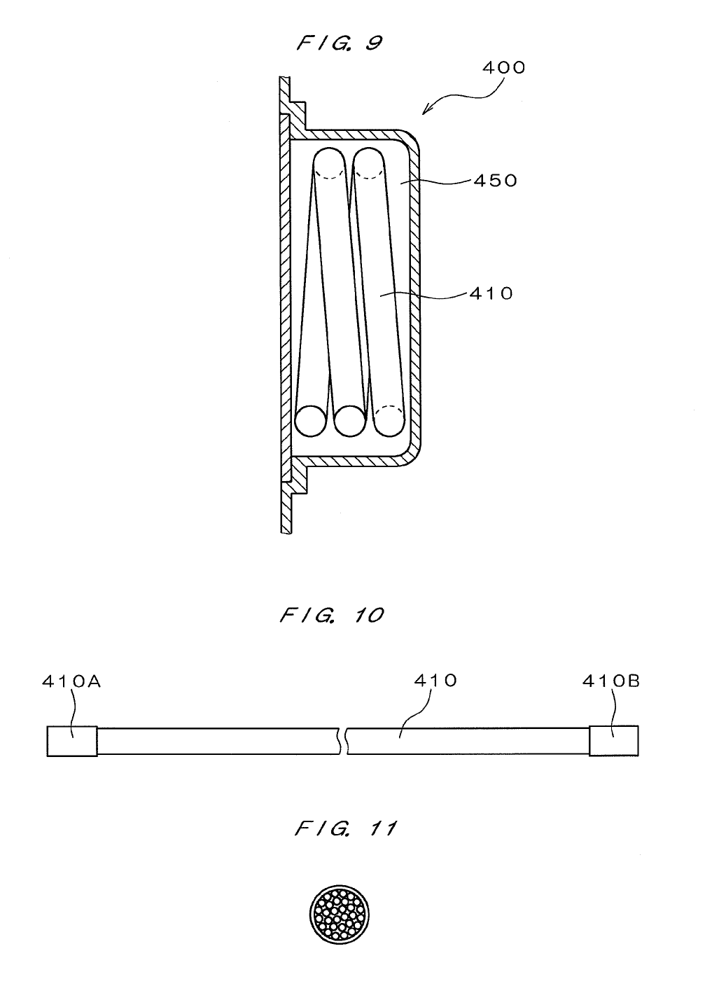

Next, a nitrogen gas supply mechanism incorporated in the control unit 200 is explained. FIG. 8 is a view showing the general construction of the nitrogen gas supply mechanism, and FIG. 9 is a side view of a hollow yarn bundle contained in the nitrogen gas supply mechanism. As shown in FIGS. 8 and 9, a nitrogen gas supply mechanism 400 includes a hollow yarn bundle 410, air one-touch joints 420 and 422, a compressed air intake port 424, a flow control section 430, a flowmeter 440, and the iron connector 214.

FIG. 10 is a view showing a state in which the hollow yarn bundle 410 is extended into a straight line shape, and FIG. 11 is an enlarged side view showing an end portion of the hollow yarn bundle 410 shown in FIG. 10. The hollow yarn bundle 410 is formed as follows: three hundred polyimide hollow yarns, which serve as a semipermeable membrane for separating nitrogen, each having a length of 1 m, an outside diameter of 0.3 mm, and an inside diameter of 0.2 mm are bundled together, and both ends of the hollow yarn bundle 410 are stiffened with epoxy resin to form epoxy fixing portions 410A and 410B. The hollow yarn bundle 410 is stored in a storage chamber 450 in a state of being wound two turns. In such a storage state, the epoxy fixing portion 410A of one end portion is connected to one air one-touch joint 420, and the epoxy fixing portion 410B of the other end portion is connected to the other air one-touch joint 422. The air one-touch joint 420 communicates with the compressed air intake port 424. A compressed air supply pipe (not shown) is connected to this compressed air intake port 424, and compressed air is supplied from one end of the hollow yarn bundle 410. Thereby, during the time when the compressed air passes in the internal spaces of polyimide hollow yarns contained in the hollow yarn bundle 410, oxygen in the air, having small molecules, passing through a polyimide hollow yarn membrane is removed selectively, so that nitrogen gas can be taken out from the other end of the hollow yarn bundle 410. For example, by using the above-described hollow yarn bundle 410, nitrogen gas of 0.5 to 1 liter per minute can be taken out continuously. It is to be noted that these specific dimensions etc. of the hollow yarn bundle 410 are one example, and can be changed appropriately according to the takeout amount of nitrogen gas. For example, the number, length, material, and the like of polyimide hollow yarns may be changed. Also, in the example shown in FIG. 9, the number of turns of the hollow yarn bundle 410 is approximately two. However, the number of turns may be other than two, namely, for example, may be three or more, or one or less than one.

The nitrogen gas supplied from the other end of the hollow yarn bundle 410 is guided to the flow control section 430 via the other air one-touch joint 422. The flow control section 430 sets the flow rate of nitrogen gas corresponding to the rotation position of a flow control dial 432. By turning the flow control dial 432, the cross-sectional area of nitrogen gas flow path can be decreased or increased, and the flow rate of nitrogen gas corresponding to the cross-sectional area of nitrogen gas flow path determined by the rotation position of the flow control dial 432 is set. The flowmeter 440 shows the flow rate of nitrogen gas in a visible state. In this embodiment, by reading the scale corresponding to the height position of a float 442, the flow rate of nitrogen gas can be seen. Thus, the nitrogen gas supplied from the hollow yarn bundle 410 is guided to the iron connector 214 after passing through the flow control section 430 and the flowmeter 440. In FIG. 8, the iron connector 214 is shown above the flowmeter 440 for convenience. Actually, however, the iron connector 214 is provided at a predetermined position lower than the flowmeter 440 and the flow control dial 432 as shown in FIG. 2.

Thus, in the soldering apparatus 100 of this embodiment, by incorporating the nitrogen gas supply mechanism 400 in the control unit 200, nitrogen gas can be supplied for each soldering iron unit 300. Therefore, flow control etc. can be carried out for each soldering iron unit 300, so that the operability and workability can be increased.

Also, in the nitrogen gas supply mechanism 400, since the turned hollow yarn bundle 410 is used, the hollow yarn bundle 410 can be stored in the control unit 200, so that the size and cost of the soldering apparatus 100 including the control unit 200 can be reduced. In particular, since the hollow yarn bundle 410 can be freely attached to and detached from the air one-touch joints 420 and 422 provided on the control unit 200, the hollow yarn bundle 410 is easily replaced at regular time intervals, so that the workability can be increased.

Furthermore, since the soldering iron unit 300 can be connected to the control unit 200 via the cable-containing tube 330, which is one tubular member, the cable-containing tube 330 can easily be dragged about as compared with the case where an electrical wiring and a nitrogen gas supply tube are provided separately, which further increases the workability.

Also, since the iron tip 312 of the soldering iron unit 300 has an outer peripheral surface that is in close contact with the inner peripheral surface of the blowout nozzle 310A, and the blowout grooves 312A and 312B for blowing out nitrogen gas are formed in parts of the outer peripheral surface, the diameter of the blowout nozzle 310A surrounding the iron tip 312 can be decreased, by which the workability can be increased.

Also, the control unit 200 is provided with the rotating sponge elements 220A and 220B, and the turning pin 222 which supplies water in the water tank 224 to the sponge elements 220A and 220B while rotating and removes solder residues adhering to the faces of the sponge elements 220A and 220B. Thereby, the sponge elements 220A and 220B serving as iron tip cleaners can always be kept in a state of being moistened with water. Moreover, since solder residues adhering to the sponge elements 220A and 220B can be removed automatically, the labor and time for maintenance requiring the interruption of soldering work can be reduced significantly.

The present invention is not limited to the above-described embodiment, and various changes and modifications can be made without departing from the spirit and scope of the present invention. In the above-described embodiment, the work for replacing the hollow yarn bundle 410 is performed by directly mounting and demounting the hollow yarn bundle 410 to and from the air one-touch joints 420 and 422 in the control unit 200. However, the configuration may be such that the whole of the storage chamber 450 that stores the hollow yarn bundle 410 is made as a cassette (cartridge), and the work for replacing the hollow yarn bundle 410 is performed by attaching and detaching the cassette provided with the hollow yarn bundle 410.

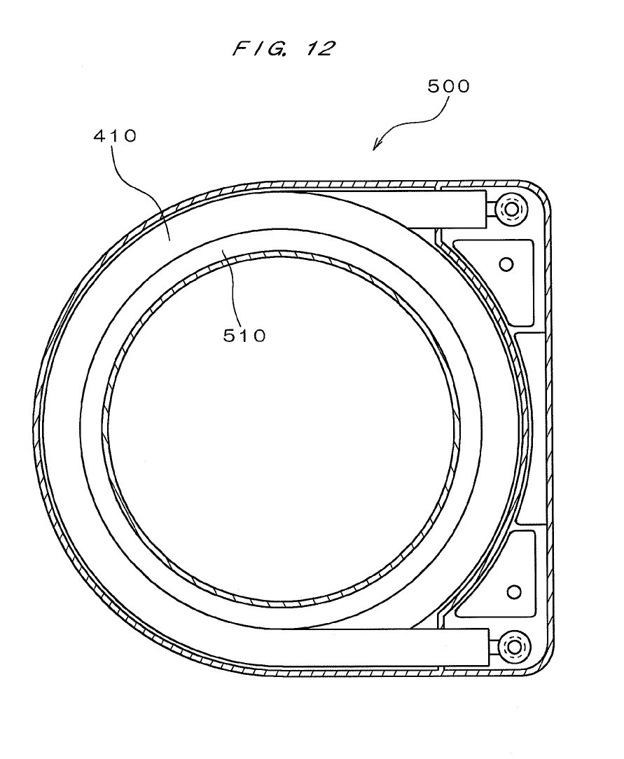

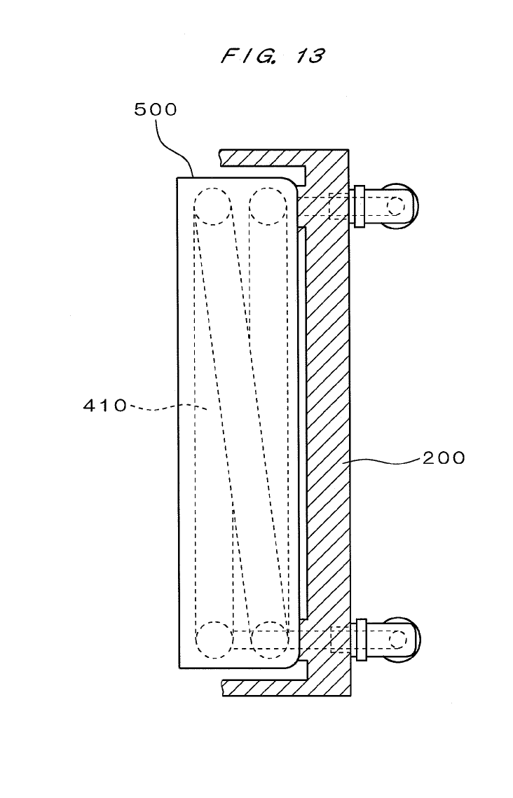

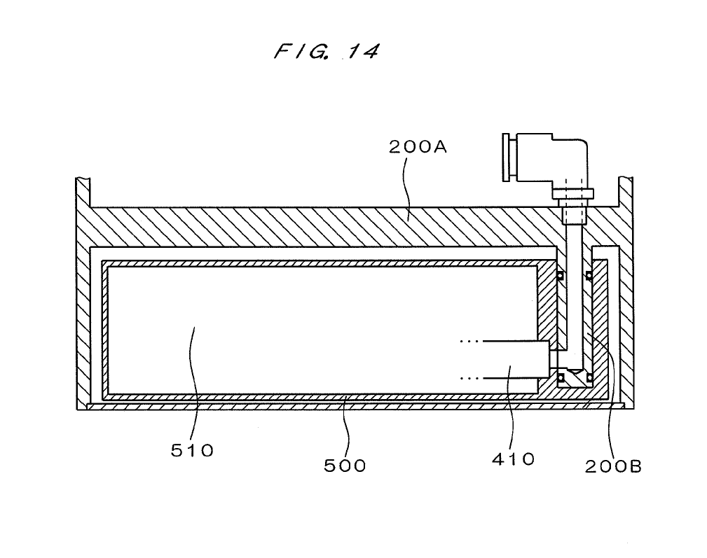

FIG. 12 is a sectional view of a hollow yarn bundle cassette, FIG. 13 is a side view thereof, and FIG. 14 is a top view thereof. As shown in these figures, a hollow yarn bundle cassette 500 is formed into a cartridge by covering a storage chamber 510, which stores the hollow yarn bundle 410, with a housing so that an air passage (concave portion) on the hollow yarn bundle cassette 500 side is attached to and detached from an air passage 200B projecting on a control unit 200A. Thereby, the cassette that stores the hollow yarn bundle 410 has only to be replaced. Therefore, the replacement work is further easy, and damage etc. occurring at the work time can be prevented as compared with the case where only the hollow yarn bundle 410 is replaced in an exposed state.

What is claimed is:

1. A soldering apparatus comprising a soldering iron unit having an iron tip heated by a heater unit and a blowout nozzle for blowing out nitrogen gas from near the iron tip; and a control unit connected to the soldering iron unit, wherein
the control unit incorporates a nitrogen gas supply mechanism for separating nitrogen gas from compressed air by using a hollow yarn bundle serving as a semipermeable membrane for separating nitrogen, which is formed by bundling a plurality of hollow yarns.

2. The soldering apparatus according to claim 1, wherein the hollow yarn bundle is stored in a turned state in a storage chamber provided in the control unit.

3. The soldering apparatus according to claim 2, wherein the hollow yarn bundle can be freely attached to and detached from a joint provided on the control unit.

4. The soldering apparatus according to claim 2, wherein the storage chamber can be freely attached to and detached from the control unit in a state in which the hollow yarn bundle is stored.

5. The soldering apparatus according to claim 1, wherein the soldering iron unit and the control unit are connected to each other via a tubular member having flexibility and being capable of maintaining gastightness of an internal space thereof, and
a heater cable for supplying a current to the heater unit is contained in the tubular member in a state in which some internal space within the tubular member is left, thereby using the internal space as a nitrogen gas supply path.

6. The soldering apparatus according to claim 1, wherein the iron tip has an outer peripheral surface that is in close contact with an inner peripheral surface of the blowout nozzle, and has a blowout groove for blowing out nitrogen gas in a part of the outer peripheral surface.

7. The soldering apparatus according to claim 1, wherein the control unit further includes a rotating sponge element and a turning pin which supplies water in a water tank to the sponge element while rotating and removes solder residues adhering to a face of the sponge element.
